(19) United States
(12) Patent Application Publication
(10) Pub. No.: US 2006/0025508 A1
(43) Pub. Date: Feb. 2, 2006

(54) Use of polyolefin waxes in polycondensates

(75) Inventors: Christian Lechner, Hurlach (DE); Gerd Hohner, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/182,467

(22) Filed: Jul. 15, 2005

(30) Foreign Application Priority Data
Jul. 23, 2004 (DE) 10 2004 035 837.0

(51) Int. Cl. C08L 91/06

(52) U.S. Cl. 524/275

(57) ABSTRACT

The invention relates to the use of polyolefin waxes as processing aids and/or dispersing agents in polycondensates, wherein the polyolefin waxes have been prepared with the aid of metallocene catalysts.

The present invention is described in the German priority application No.102004035837.0, filed 23.07.2004, which is hereby incorporated by reference as is fully disclosed herein.

The invention relates to the use of polyolefin waxes as processing aids or dispersing agents in polycondensates.

The processing of thermoplastics from the melt is attended by a high level of thermal and mechanical stress. In order to eliminate product degradation thus caused, additives are used, examples being stabilizers, lubricants, antioxidants, release agents, dispersing agents, and others.

It is known that various waxes can be used as (mold-)release agents, lubricants, and dispersing agents in particular in polyamides, such as nylon-6 and nylon-6,6, and also in polyesters, such as polyethylene terephthalate and polybutylene terephthalate. (Mold-)release agents often used (JP-A-58/219255) comprise amide waxes and montan wax esters, polyethylene waxes, or low-molecular-weight ethylene-acrylic acid copolymers, and also metal stearates. Waxes are also used as lubricants in order to improve the flow behavior of the melt. Addition of the lubricant reduces internal and external friction and mitigates mechanicochemical degradation of the material. The function of lubricants is to give controlled and adequate disintegration of the plastic in the processing machine and to give a homogeneous melt; they prevent excessive adhesion of the plastics melt to hot machine components and improve the flow properties of the plastics melt.

Waxes can also be used in polycondensates as dispersing agents for pigments, fillers, and reinforcing materials. The coloring of polyamides and polyesters is difficult because high processing temperatures are needed, shear stress is high, and the melt is chemically aggressive toward colorants; the selection of the colorants (pigments) that can be used is restricted. Waxes of the abovementioned type, or else stearate soaps, are therefore used as dispersing agents during the incorporation of pigments, and also of fillers and reinforcing agents.

The abovementioned additives may be introduced into the plastic at various points in preparation or processing, for example during the polycondensation process, or in a compounding step subsequent to the polycondensation process. It is also possible to apply pulverulent waxes to the (warm) plastics pellets in a drum.

The activity profiles of the waxes used hitherto for polyesters and polyamides are not always satisfactory with respect to their lubricant action, release action, and dispersing action.

It was therefore an object to provide improved wax additives for these applications. Surprisingly, it has now been found that polyolefin waxes prepared by means of metallocene catalysts are suitable and superior auxiliaries during polycondensate processing. They can moreover also be used as dispersing agent during the incorporation of pigments, and also of fillers or of reinforcing material.

The invention therefore provides the use of polyolefin waxes as processing aids and/or dispersing agents in polycondensates, wherein the polyolefin waxes have been prepared with the aid of metallocene catalysts. The polyolefin waxes may be used either in unaltered form or else in a form that has been subjected to polar modification. The expression “polyolefin waxes” below means both forms.

The polyolefin waxes are preferably composed of ethylene units and/or of unbranched or branched olefin units having from 3 to 18 carbon atoms.

The polyolefin waxes have preferably been subjected to polar modification.

The polyolefin waxes have preferably been subjected to polar modification via oxidation with oxygen or with oxygen-containing gases, or via free-radical grafting with α,β-unsaturated carboxylic acids or with their derivatives.

It is preferable that the drop point or ring/ball softening point of the polyolefin waxes is from 85 to 165° C., their melt viscosity, measured 10° C. above the drop point or softening point, is from 20 to 40 000 mPa.s, and their acid number is from 0 to 60 mg KOH/g.

It is particularly preferable that the drop point or ring/ball softening point of the polyolefin waxes is from 90 to 160° C., their melt viscosity, measured 10° C. above the drop point or softening point, is from 30 to 20 000 mPa.s, and their acid number is from 0 to 40 mg KOH/g.

The condensates are preferably polyamides and/or polyesters.

The polyamides are preferably those of amino acid type and/or of diamine-dicarboxylic acid type.

The polyamides are particularly preferably nylon-6 and/or nylon-6,6.

The polyesters are particularly preferably polyethylene terephthalate and/or polybutylene terephthalate.

It is preferable that the polycondensates are unaltered, colored, filled, reinforced or modified polycondensates.

It is preferable that the polyolefin wax is used in the form of pellets, flakes, fine grains, powder, and/or micronizate.

It is preferable that the polyolefin waxes are incorporated during polycondensation or compounding, or during the shaping process.

It is preferable that the polyolefin waxes are used in the form of masterbatches.

It is preferable that the amount used of the polyolefin waxes is from 0.01 to 10.00% by weight, based on the polycondensate.

It is preferable that the amount used of the polyolefin waxes is from 0.1 to 2.00% by weight, based on the polycondensate.

Polyolefin waxes which may be used are homopolymers of ethylene or of higher 1-olefins or their copolymers. 1-Olefins used are linear or branched olefins having from 3 to 18 carbon atoms, preferably from 3 to 6 carbon atoms. These olefins may have aromatic substitution conjugated with the olefinic double bond. Examples here are propene, 1-butene, 1-hexene, 1-octene or 1-octadecene, and also styrene. Preference is given to homopolymers of ethylene or of propene, or their copolymers with one another. The copolymers are composed of from 70 to 99.9% by weight, preferably from 80 to 99% by weight, of one type of olefin.

Suitable waxes are olefin homo- and copolymer waxes with weight-average molar mass M_{w} of from 1000 to 30 000 g/mol, preferably from 2000 to 20 000 g/mol, with number-average molar mass Mₙ from 500 to 20 000 g/mol, preferably from 1000 to 10 000 g/mol, with drop point or ring/ball softening point of from 80 to 165° C., preferably from 90 to 160° C., and with melt viscosity, measured at a temperature 10° C. above the drop point or softening point, of not more than 40 000 mPa.s, preferably from 100 to 20 000 mPa.s.

The molar masses here were determined by means of gel permeation chromatography, the drop points were determined to DIN 51801/2, the ring/ball softening points were determined to DIN EN 1427, and the melt viscosities were determined to DIN 53019 using a rotary viscometer.

Metallocene compounds of the formula I were used for preparation of the polyolefin waxes used according to the invention.

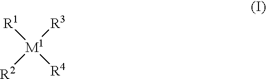

This formula also encompasses compounds of the formula Ia 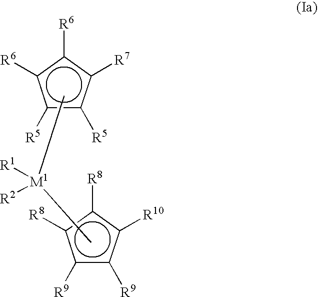
or the formula Ib 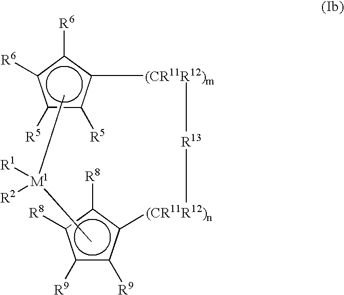
and of the formula Ic

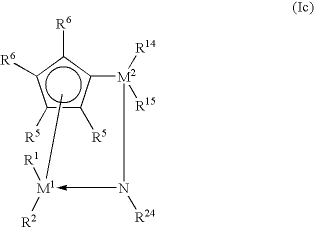

In the formulae I, Ia and Ib, M¹ is a metal of group IVb, Vb, or VIb of the Periodic Table, e.g. titanium, zirconium, hafnium, vanadium, niobium, tantalum, chromium, molybdenum, tungsten, preferably titanium, zirconium, hafnium.

R¹ and R² are identical or different and are a hydrogen atom, a C₁-C₁₀-alkyl group, preferably C₁-C₃-alkyl group, in particular methyl, a C₁-C₁₀-alkoxy group, preferably C₁-C₃-alkoxy group, a C₆-C₁₀-aryl group, preferably C₆-C₈-aryl group, a C₆-C₁₀-aryloxy group, preferably C₆-C₈-aryloxy group, a C₂-C₁₀-alkenyl group, preferably C₂-C₄-alkenyl group, a C₇-C₄₀-arylalkyl group, preferably C₇-C₁₀-arylalkyl group, a C₇-C₄₀-alkylaryl group, preferably C₇-C₁₂-alkylaryl group, a C₈-C₄₀-arylalkenyl group, preferably C₈-C₁₂-arylalkenyl group, or a halogen atom, preferably a chlorine atom.

R³ and R⁴ are identical or different and are a mono- or polynuclear hydrocarbon radical which can form a sandwich structure with the central atom M¹. R³ and R⁴ are preferably cyclopentadienyl, indenyl, tetrahydroindenyl, benzoindenyl, or fluorenyl, and the parent structures here may also bear additional substituents or may have bridging to one another. One of the radicals R³ and R⁴ may moreover be a substituted nitrogen atom, where R²⁴ is as defined for R¹⁷ and is preferably methyl, tert-butyl, or cyclohexyl.

R⁵, R⁶, R⁷, R⁸, R⁹, and R¹⁰ are identical or different and are a hydrogen atom, a halogen atom, preferably a fluorine atom, chlorine atom, or bromine atom, a C₁-C₁₀-alkyl group, preferably C₁-C₄-alkyl group, a C₆-C₁₀-aryl group, preferably C₆-C₈-aryl group, a C₁-C₁₀-alkoxy group, preferably C₁-C₃-alkoxy group, an —NR¹⁶₂—, —SR¹⁶—, —OSiR¹⁶₃—, —SiR¹⁶₃—, or —PR¹⁶₂— radical, where R¹⁶ is a C₁-C₁₀-alkyl group, preferably C₁-C₃-alkyl group, or C₆-C₁₀-aryl group, preferably C₆-C₈-aryl group, or in the case of Si- or P-containing radicals, a halogen atom, preferably a chlorine atom, or any two adjacent radicals R⁵, R⁶, R⁷, R⁸, R⁹, or R¹⁰ form a ring with the carbon atoms connecting them. Particularly preferred ligands are the substituted compound structures derived from the parent structures cyclopentadienyl, indenyl, tetrahydroindenyl, benzoindenyl, or fluorenyl.

R¹³ is 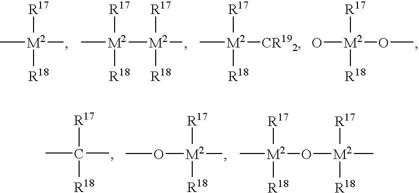
═BR¹⁷, ═AlR¹⁷, —Ge—, —Sn—, —O—, —S—, ═SO, ═SO₂, ═NR¹⁷, ═CO, ═PR¹⁷ or ═P(O)R¹⁷, where R ⁷, R¹⁸, and R¹⁹ are identical or different and are a hydrogen atom, a halogen atom, preferably a fluorine atom, chlorine atom, or bromine atom, a C₁-C₃₀-alkyl group, preferably C₁-C₄-alkyl group, in particular a methyl group, a C₁-C₁₀-fluoroalkyl group, preferably CF₃ group, a C₆-C₁₀-fluoroaryl group, preferably pentafluorophenyl group, a C₆-C₁₀-aryl group, preferably C₆-C₈-aryl group, a C₁-C₁₀-alkoxy group, preferably C₁-C₄-alkoxy group, in particular a methoxy group, a C₂-C₁₀-alkenyl group, preferably C₂-C₄-alkenyl group, a C₇-C₄₀-aralkyl group, preferably C₇-C₁₀-aralkyl group, a C₈-C₄₀-arylalkenyl group, preferably C₈-C₁₂-arylalkenyl group, or a C₇-C₄₀-alkylaryl group, preferably C₇-C₁₂-alkylaryl group, or R¹⁷ and R¹⁸, or R¹⁷ and R¹⁹ form a ring in each case together with the atoms connecting them.

M² is silicon, germanium, or tin, preferably silicon and germanium. R¹³ is preferably ═CR¹⁷R¹⁸, ═SiR¹⁷R¹⁸, ═GeR¹⁷R¹⁸, —O—, —S—, ═SO, ═PR¹⁷, or ═P(O)R¹⁷.

R¹¹ and R¹² are identical or different and are as defined for R¹⁷. m and n are identical or different and are zero, 1 or 2, preferably zero or 1, where m+n is zero, 1 or 2, preferably zero or 1.

R¹⁴ and R¹⁵ are as defined for R¹⁷ and R¹⁸.

Examples of suitable metallocenes are: bis(1,2,3-trimethylcyclopentadienyl)zirconium dichloride, bis(1,2,4-trimethylcyclopentadienyl)zirconium dichloride, bis(1,2-dimethylcyclopentadienyl)zirconium dichloride, bis(1,3-dimethylcyclopentadienyl)zirconium dichloride, bis(1-methylindenyl)zirconium dichloride, bis(1-n-butyl-3-methylcyclopentadienyl)zirconium dichloride, bis(2-methyl-4,6-di-isopropylindenyl)zirconium dichloride, bis(2-methylindenyl)zirconium dichloride, bis(4-methylindenyl)zirconium dichloride, bis(5-methylindenyl)zirconium dichloride, bis(alkylcyclopentadienyl)zirconium dichloride, bis(alkylindenyl)zirconium dichloride, bis(cyclopentadienyl)zirconium dichloride, bis(indenyl)zirconium dichloride, bis(methylcyclopentadienyl)zirconium dichloride, bis(n-butylcyclopentadienyl)zirconium dichloride, bis(octadecylcyclopentadienyl)zirconium dichloride, bis(pentamethylcyclopentadienyl)zirconium dichloride, bis(trimethylsilylcyclopentadienyl)zirconium dichloride, biscyclopentadienyldibenzylzirconium, biscyclopentadienyldimethylzirconium, bistetrahydroindenylzirconium dichloride, dimethylsilyl-9-fluorenylcyclopentadienylzirconium dichloride, dimethylsilylbis-1-(2,3,5-trimethylcyclopentadienyl)zirconium dichloride, dimethylsilylbis-1-(2,4-dimethylcyclopentadienyl)zirconium dichloride, dimethylsilylbis-1-(2-methyl-4,5-benzoindenyl)zirconium dichloride, dimethylsilylbis-1-(2-methyl-4-ethylindenyl)zirconium dichloride, dimethylsilylbis-1-(2-methyl-4-isopropylindenyl)zirconium dichloride, dimethylsilylbis-1-(2-methyl-4-phenylindenyl)zirconium dichloride, dimethylsilylbis-1-(2-methylindenyl)zirconium dichloride, dimethylsilylbis-1-(2-methyltetrahydroindenyl)zirconium dichloride, dimethylsilylbis-1-indenylzirconium dichloride, dimethylsilylbis-1-indenyldimethylzirconium, dimethylsilylbis-1-tetrahydroindenylzirconium dichloride, diphenylmethylene-9-fluorenylcyclopentadienylzirconium dichloride, diphenylsilylbis-1-indenylzirconium dichloride, ethylenebis-1-(2-methyl-4,5-benzoindenyl)zirconium dichloride, ethylenebis-1-(2-methyl-4-phenylindenyl)zirconium dichloride, ethylenebis-1-(2-methyltetrahydroindenyl)zirconium dichloride, ethylenebis-1-(4,7-dimethylindenyl)zirconium dichloride, ethylenebis-1-indenylzirconium dichloride, ethylenebis-1-tetrahydroindenylzirconium dichloride, indenylcyclopentadienylzirconium dichloride isopropylidene(1-indenyl)(cyclopentadienyl)zirconium dichloride, isopropylidene(9-fluorenyl)(cyclopentadienyl)zirconium dichloride, phenylmethylsilylbis-1-(2-methylindenyl)zirconium dichloride, and also each of the alkyl or aryl derivatives of these metallocene dichlorides.

Suitable cocatalysts are used to activate the single-centre catalyst systems. Suitable cocatalysts for metallocenes of the formula I are organoaluminum compounds, in particular aluminoxanes, or else aluminum-free systems, such as R²⁰ₓNH₄₋ₓBR²¹₄, R²⁰ₓPH₄₋ₓBR²¹₄, R²⁰₃CBR²¹₄ or BR²¹₃. x in these formulae is a number from 1 to 4, and the radicals R²⁰ are identical or different, preferably identical, and are C₁-C₁₀-alkyl or C₆-C₁₈-aryl, or two radicals R²⁰ form a ring together with the atom connecting them, and the radicals R²¹ are identical or different, preferably identical, and are C₆-C₁₈-aryl, which may have substitution by alkyl, by haloalkyl, or by fluorine. In particular, R²⁰ is ethyl, propyl, butyl, or phenyl, and R²¹ is phenyl, pentafluorophenyl, 3,5-bistrifluoromethylphenyl, mesityl, xylyl, or tolyl.

A third component is also often required in order to maintain protection from polar catalyst poisons. Organoaluminum compounds are suitable for this purpose, examples being triethylaluminum, tributylaluminum, and others, and also mixtures.

As a function of the process, it is also possible to use supported single-centre catalysts. Preference is given to catalyst systems in which the residual contents of support material and cocatalyst do not exceed a concentration of 100 ppm in the product.

The documents EP-A-0 321 851, EP-A-0 321 852, and EP-A-0 384 264 describe by way of example the preparation of these polyolefin waxes.

The waxes may be used in unaltered form, or else in a form that has been subjected to polar modification. Waxes subjected to polar modification are obtained in a manner known per se from non-polar waxes via oxidation by oxygen-containing gases, such as air, or via a free-radical graft reaction using polar monomers, such as α,β-unsaturated carboxylic acids or their derivatives. Examples of α,β-unsaturated carboxylic acids or their derivatives are acrylic, methacrylic, or maleic acid, and also esters, amides, or anhydrides of the acids mentioned. A process to subject metallocene waxes to polar modification via oxidation is described by way of example in EP 0 890 583, and the modification process via grafting is described by way of example in U.S. Pat. No. 5,998,547.

The waxes that have been subjected to polar modification have weight-average molar masses M_{w} of from 1000 to 30 000 g/mol, preferably from 2000 to 20 000 g/mol, number-average molar masses Mₙ from 500 to 20 000 g/mol, preferably from 1000 to 10 000 g/mol, drop point or ring/ball softening point of from 80 to 165° C., preferably from 90 to 160° C., melt viscosities, measured at a temperature 10° C. above the drop point or softening point, of not more than 40 000 mPa.s, preferably from 100 to 20 000 mPa.s, and acid numbers of from 0 to 60 mg KOH/g, preferably from 0 to 40 mg/KOH/g.

The acid numbers are determined to DIN 53402.

The wax is preferably used in the form of pellets, flakes, powder, and/or micronizate.

The incorporation of waxes preferably takes place during polycondensation or compounding, or during the shaping process.

By way of example, the metallocene waxes are incorporated into the polycondensates via mixing or adsorption of the same onto the cold or warm carrier polymer and its subsequent processing through a shaping processing step (e.g. injection molding, flat-foil production, calendering), or via compounding by means of an extruder, where the wax can be mixed with the plastic prior to the extrusion process or can be introduced by means of a side feed during the extrusion process.

### EXAMPLES

The waxes to be used according to the invention were tested in unreinforced nylon-6, and in nylon-6 reinforced with 30% of glass fiber, and also in unreinforced polybutylene terephthalate, and polybutylene terephthalate reinforced with 30% of glass fiber. The non-inventive comparative examples used firstly the unmodified polymer and an unmodified Ziegler polyethylene wax (Licowax® PE 520, Clariant GmbH), a montan wax (Licowax® E, Clariant GmbH), an ethylene-acrylic acid copolymer wax (A-C® 540, Honeywell), an amide wax (ethylenebisstearamide, Licolub® FA 1, Clariant GmbH), and calcium stearate.

TABLE 1
Waxes used

| | | | Viscosity | |
|---|---|---|---|---|
| | | Drop point | (140° C.) | Acid number |
| | Wax type | ° C. | mPa · s | mg KOH/g |
| inventive | TP Licocene ® PE 4201 | 128 | 60 | — |
| inventive | TP Licocene ® PE MA 4221 | 126 | 100 | 17 |
| | (metallocene PE wax, grafted with 3% | | | |
| | by weight of maleic anhydride) | | | |
| comparison | Licowax ® PE 520 | 118 | 650 | — |
| comparison | Licowax ® E | 82 | 30/100° C. | 18 |
| comparison | A-C ® 540 | 105 | 580 | 40 |
| comparison | Licolub ® FA 1 | 142 | 10/150° C. | 6 |

In all of the experiments (other than pigment dispersion), the amount used of the waxes, based on the polycondensate, was 0.3% by weight. Release action was studied, as were flow improvement, color, mechanical properties and dispersing action for pigments.

The waxes were mixed into the polymer pellets, compounded by means of a twin-screw extruder, and then processed via injection molding after predrying.

All of the series of experiments were carried out under identical conditions (temperature programs, screw geometries, injection molding parameters, etc.).

### Example 1

### Release Action

The release action (external lubricant action) of lubricants in engineering plastics, such as polyamides and polyesters, is quantified via measurement of demolding force during injection molding. For this, a cylindrical shell is produced by the injection molding process and the maximum force needed to demold the shell from the mold is recorded as demolding force. The lower the demolding force, the better the external lubricant action of the lubricant used.

TABLE 2
Study of release action

| Demolding | Nylon-6 | | Polybutylene terephthalate | |
|---|---|---|---|---|
| force [N] | Unreinforced | Reinforced | Unreinforced | Reinforced |
| Without wax | >10 000 | 2500 | 7500 | 4600 |
| TP Licocene ® | 500 | 850 | 800 | 1100 |
| PE 4201 | | | | |
| TP Licocene ® | 450 | 750 | 750 | 1050 |
| PE MA 4221 | | | | |
| Licowax ® | 700 | 1100 | 950 | 1600 |
| PE 520 | | | | |
| Licolub FA 1 | 650 | 1200 | 800 | 1250 |
| Licowax E | 550 | 950 | 850 | 1100 |
| A-C ® 540 | 750 | 1300 | 950 | 1650 |
| Calcium | 700 | 1250 | 900 | 1150 |
| stearate | | | | |

### Example 2

### Flow Improvement

The flow improvement (internal lubricant action) brought about via lubricants in engineering plastics, such as polyamides and polyesters, is quantified via determination of flow path by means of what is known as the spiral test. For this, a spiral involving a scale is produced by the injection molding process and the length is determined. The longer the flow path (i.e. the spiral), the better the internal lubricant action, i.e. the flowability of the polymer.

TABLE 3
Study of flow improvement

| Flow spiral | Nylon-6 | | Polybutylene terephthalate | |
|---|---|---|---|---|
| length [cm] | Unreinforced | Reinforced | Unreinforced | Reinforced |
| Without wax | 41.5 | 36.2 | 37.5 | 27.3 |
| TP Licocene ® | 44.0 | 40.5 | 38.9 | 29.0 |
| PE 4201 | | | | |
| TP Licocene ® | 44.2 | 40.8 | 39.0 | 29.3 |
| PE MA 4221 | | | | |
| Polyethylene | 41.5 | 36.9 | 37.7 | 27.3 |
| wax | | | | |
| Amide wax | 42.3 | 37.6 | 38.3 | 28.1 |
| Montan wax | 43.9 | 40.3 | 37.9 | 28.8 |
| ester | | | | |
| Ethylene- | 40.9 | 36.3 | 37.3 | 26.9 |
| acrylic | | | | |
| acid copolymer | | | | |
| Calcium | 42.5 | 39.2 | 38.1 | 27.9 |
| stearate | | | | |

### Example 3

### Color Measurement

The method for producing the injection-molded sheets for color measurement was analogous to that of Examples 1 and 2. The yellowness index was determined on the resultant sheets by means of a colorimeter (Minolta CM 3600 d). The lower the yellowness index, the paler and whiter is the appearance of the article.

TABLE 4
Color action

| Yellowness | Nylon-6 | | Polybutylene terephthalate | |
|---|---|---|---|---|
| index | Unreinforced | Reinforced | Unreinforced | Reinforced |
| Without wax | 5 | 16 | 6 | 18 |
| TP Licocene ® | 6 | 14 | 6 | 19 |
| PE 4201 | | | | |
| TP Licocene ® | 5 | 13 | 6 | 18 |
| PE MA 4221 | | | | |
| Polyethylene | 7 | 16 | 7 | 19 |
| wax | | | | |
| Amide wax | 7 | 16 | 8 | 19 |
| Montan wax | 9 | 18 | 9 | 20 |
| ester | | | | |
| Ethylene- | 7 | 15 | 7 | 19 |
| acrylic | | | | |
| acid copolymer | | | | |
| Calcium | 7 | 17 | 8 | 19 |
| stearate | | | | |

### Example 4

### Mechanical Properties

Standard test specimens were injection molded as in Example 3, and mechanical properties (notched impact resistance) were determined.

TABLE 5
Mechanical properties (notched impact resistance)

| Notched impact | | | | |
|---|---|---|---|---|
| resistance | Nylon-6 | | Polybutylene terephthalate | |
| [kJ/m²] | Unreinforced | Reinforced | Unreinforced | Reinforced |
| Without wax | 4 | 13.5 | 6 | 10 |
| TP Licocene ® | 4 | 14 | 7 | 11 |
| PE 4201 | | | | |
| TP Licocene ® | 5 | 15 | 7 | 12 |
| PE MA 4221 | | | | |
| Polyethylene | 4 | 13 | 5 | 10 |
| wax | | | | |
| Amide wax | 4 | 13.5 | 6 | 10 |
| Montan wax | 4 | 13 | 6 | 10 |
| ester | | | | |
| Ethylene- | 4 | 13 | 6 | 9.5 |
| acrylic | | | | |
| acid copolymer | | | | |
| Calcium | 4 | 13 | 6 | 10 |
| stearate | | | | |

### Example 5

### Dispersion of Pigments

Dispersing action is quantified via what is known as the filter pressure test, which measures the pressure increase upstream of a filter with a certain mesh width. The better the dispersion of the pigments, the more easily the melt can pass through the filter. A small filter pressure value (measured in [bar/g of pigment]) therefore indicates good dispersing action of the lubricants.

The pigment selected comprised PV Fast Pink, because it is difficult to disperse either in polyamide or in polyesters. The pigments and waxes were incorporated by means of cold mixing and by compounding, using a twin-screw extruder. The pressure filter value was then determined by way of a 14 μm filter.

The starting concentrations in this example were 5% of wax, 30% by weight of PV Fast Pink pigment, and 65% by weight of polymer.

TABLE 6
Dispersion of pigments (filter pressure test)

| | | Polybutylene |
|---|---|---|
| Filter pressure test | | terephthalate, |
| [bar/g of pigment] | Nylon-6, unreinforced | unreinforced |
| TP Licocene ® PE 4201 | 3.0 | 3.0 |
| TP Licocene ® PE MA 4221 | 2.5 | 2.7 |
| Amide wax | 4.8 | 4.1 |
| Montan wax ester | 3.6 | 3.1 |
| Ethylene-acrylic acid copolymer | 6.2 | 7.3 |
| Calcium stearate | 8.4 | 7.9 |

1. A process for making a polyolefin wax comprising the step of adding at least one of a processing aid or dispersing agent to the polycondensate, wherein the processing aid or dispersing agent is a polyolefin wax and wherein the polyolefin wax has been prepared with the aid of a metallocene catalyst.

2. The process as claimed in claim 1, wherein the polyolefin wax is composed of ethylene units and/or of unbranched or branched olefin units having from 3 to 18 carbon atoms.

3. The process as claimed in claim 1, wherein the polyolefin wax is subjected to polar modification.

4. The process as claimed in claim 1, wherein the polyolefin wax is subjected to polar modification via oxidation with oxygen or with oxygen-containing gases, or via free-radical grafting with α,β-unsaturated carboxylic acids or with their derivatives.

5. The process as claimed in claim 1, wherein the drop point or ring/ball softening point of the polyolefin wax is from 85 to 165° C., the melt viscosity, measured 10° C. above the drop point or softening point, is from 20 to 40 000 mPa.s, and the acid number is from 0 to 60 mg KOH/g.

6. The process as claimed in claim 1, wherein the drop point or ring/ball softening point of the polyolefin wax is from 90 to 160° C., the melt viscosity, measured 10° C. above the drop point or softening point, is from 30 to 20 000 mPa.s, and the acid number is from 0 to 40 mg KOH/g.

7. The process as claimed in claim 1, wherein the polycondensate is a polyamide, a polyester or a mixture thereof.

8. The process as claimed in claim 1, wherein the polyamide is of the amino acid type and/or of the diamine-dicarboxylic acid type.

9. The process as claimed in claim 7, wherein the polyamide is nylon-6 nylon-6,6 or a mixture thereof.

10. The process as claimed in claim 7, wherein the polyester is polyethylene terephthalate polybutylene terephthalate or a mixture thereof.

11. The process as claimed in claim 1, wherein the polycondensate is an unaltered, colored, filled, reinforced or modified polycondensate.

12. The process as claimed in claim 1, wherein the polyolefin wax is in the form of pellets, flakes, fine grains, powder, microizates or mixtures thereof.

13. The process as claimed in claim 1, wherein the polyolefin wax is added during polycondensation or compounding, or during the shaping process.

14. The process as claimed in claim 1, wherein the polyolefin wax is in the form of a masterbatch.

15. The process as claimed in claim 1, wherein the amount of the polyolefin wax is from 0.01 to 10.00% by weight, based on the polycondensate.

16. The process as claimed in claim 1, wherein the amount of the polyolefin wax is from 0.1 to 2.00% by weight, based on the polycondensate.

17. A polycondensate made in accordance with the process of claim 1.
